(19) United States
(12) Patent Application Publication
(10) Pub. No.: US 2003/0055645 A1
(43) Pub. Date: Mar. 20, 2003

(54) Apparatus with speech recognition and method therefor

(76) Inventor: Meir Griniasty, Tel Aviv, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/956,497

(22) Filed: Sep. 18, 2001

(51) Int. Cl. G10L 15/14

(52) U.S. Cl. 704/256

(57) ABSTRACT

Briefly, in accordance with one embodiment of the invention, a recognition system may modify speech models using noise in an input signal that is received prior to a speech sample in the input sample.

### BACKGROUND

In speech recognition systems, it may be desirable to separate the noise from the speech data included within an input sample. To do so, the input sample may be passed through a speech recognition process twice; the first pass to identify the noise, and the second pass to isolate and process the speech data once the noise has been accounted for.

However, such two-pass systems typically involve the use of memory to store the input sample so that it is available to be passed through the speech recognition system more than once. The use of memory to store the input signal increases both the cost and complexity of conventional speech recognition systems. Thus, there is a continuing need for better ways to process input samples in speech recognition systems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a portable device in accordance with an embodiment of the present invention;

FIG. 2 is an illustration of a Hidden Markov Model (HMM) in accordance with an embodiment of the present invention; and

FIG. 3 is a flow chart of a process in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

It should be understood that embodiments of the present invention may be used in a variety of applications. Although the present invention is not limited in this respect, the embodiments disclosed herein may be used in many apparatuses such as portable devices. For example, embodiments of the present invention may be used with cellular radiotelephone communication systems, satellite communication systems, two-way radio communication systems, one-way pagers, two-way pagers, personal communication systems (PCS), personal digital assistants (PDA's ) and the like, although the scope of the present invention is not limited to these.

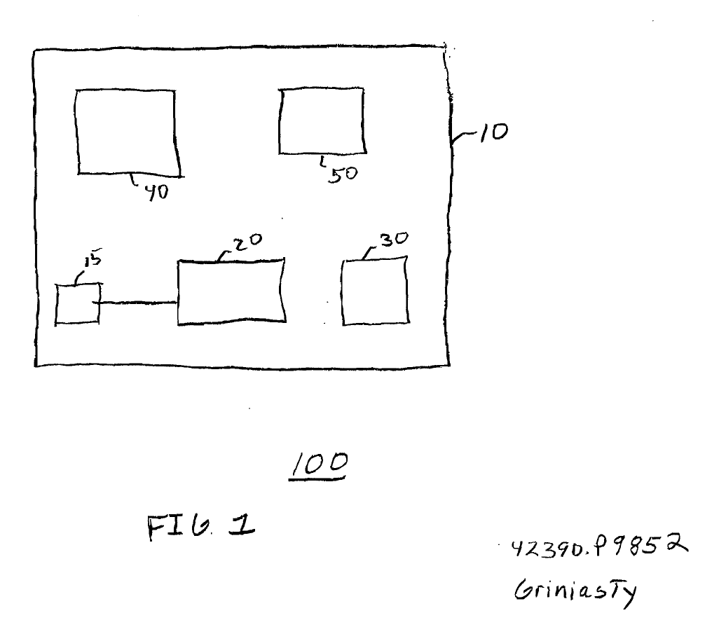

Turning to FIG. 1, an embodiment 100 in accordance with the present invention is described. Embodiment 100 may comprise a portable communication device 10 such as a mobile communication device (e.g., cell phone), a two-way radio communication system, a one-way pager, a two-way pager, a personal communication system (PCS), a portable computer, or the like. Although it should be understood that the scope and application of the present invention is in no way limited to these examples.

Portable communication device 10 here includes a processor 40 that may comprise, for example, a microprocessor, a digital signal processor, a microcontroller, or the like. Although the scope of the present invention is not limited in this respect, a user may use their voice to provide data or commands that may then be processed by processor 40. For example, a user may specify what phone number is to be dialed or what features of portable communication device 10 are to be activated.

Portable communication device 10 may also include memory such as memories 30 and 50 (e.g. RAM or non-volatile memory), although it should be understood that the scope of the present invention is not limited by the size or number of memories. In addition, memories 30 and 50 may be any type of memory including any of those described above. For example, memory 20 may be used to store instructions to be executed by processor 40 and may present the results of the execution of those instructions to a user.

As will be explained in more detail below, memory 30 may be used to store speech models that may be used to recognize or identify sounds picked up by a microphone 15 and processed by recognition system 20. For example, memory 30 may be used to store Hidden Markov Models (naïve, modified, or both) that may be used by recognition system 20 to recognize speech data provided by a user. An input signal provided by a user or machine may include both desired and undesired data. The desired data may include the speech (e.g. words, sounds, music, etc.) that is to be recognized by recognition system 20. The input signal may also include undesired data (e.g. interference, background noise, etc.). The presence of the undesired data in an input signal may make more difficult to recognized the desired data within an input sample.

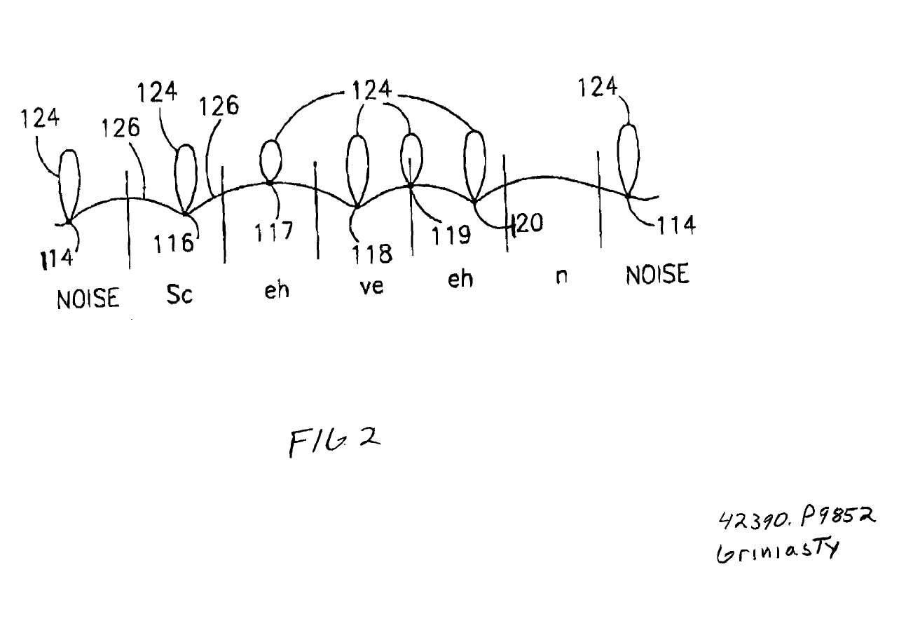

FIG. 2 is provided as an illustration of an example of a Hidden Markov Model (HMM). Memory 30 may have an HMM speech model for the words to be recognized by recognition system 20. An HMM is a statistical model that may comprise a sequence of “states” that are used to provide a description of a different part of a word. For example, FIG. 2 is an illustration of the HMM model for the word “seven.” When a user says the word “seven,” the input sample may include both noise and the speech sounds associated with the word. To identify the word, the speech recognition system may use statistical analysis to determine is the input data sample comprises the appropriate transitions or states associated with each part of a word.

As shown in FIG. 2, the input sample begins and ends with a noise state 114 and include the states 116-120 corresponding to the portions of the word “seven.” From each state, two types of motion are possible: to remain at the same state as indicated by loops 124, or to transition from one state to the next as indicated by arcs 126. When a left-to-right HMM remains in the same state, as indicated by loops 124, then the state may comprise more than one frame. When the left-to-right HMM transitions to the next state, as indicated by arcs 126, then the next frame may correspond to a different state. It should be understood that the scope of the present invention is not limited to embodiments that use Hidden Markov Models as other models may also be used.

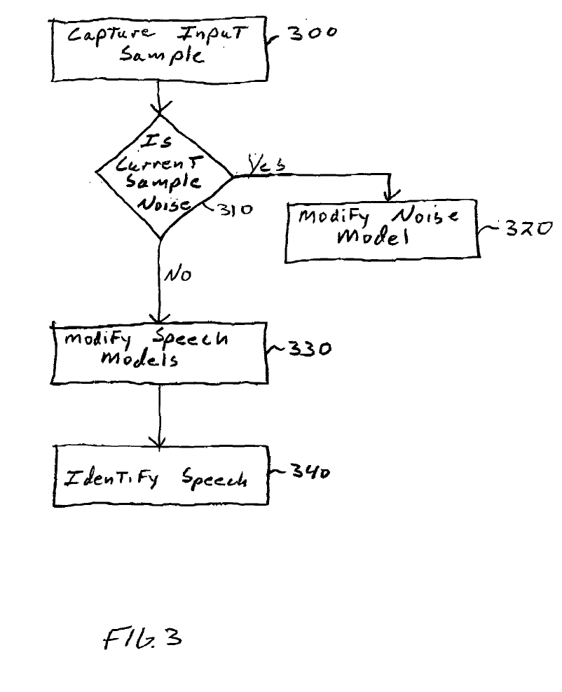

Turning now to FIG. 3 a method of recognizing speech in an input sample is provided, although is should be understood that this example is meant only to be illustrative and the scope of the present invention is not limited in this respect. This process may begin with microphone 15 capturing an input sample and providing it to recognition system 20, step 300. Although the scope of the present invention is not limited in this respect, the input sample may be sampled at about 8000 Hz and then divided into multiple frames of about 30 milliseconds each.

Before recognition, the acquired speech frame of 30 msec may be sampled at 8000 Hz (which makes 240 numbers) and transformed into a “mel cepstrum” vector (typically 13 numbers). This set of features may be achieved by the following mathematical operations, although it should be understood that the scope of the present invention is not necessarily limited to embodiments that include these operations in this particular order as other operations may be used in a variety of combinations. To begin, a Fourier transform is performed and then the absolute value squared of each frequency is calculated. Then multiply the squared Fourier amplitudes by a set of 13 mel filters to obtain a 13 dimensional mel filter bank vector and apply the logarithm operation on the elements of the vector. Then the inverse Fourier the 13 numbers to obtain 13 mel cepstrum numbers.

The HMM statistical models may be based on the same Mel features. The HMM speech states may be a mixture of 8 guasians. The gaussians may represent probability densities in the mel space and have dimension 13. The noise HMM, as shown in FIG. 2. may be a single state HMM and have a single gaussian.

Recognition system 20 may then determine if the current frame of the input sample is noise or speech, step 310. This may be done in a variety of ways and the scope of the present invention is not limited to any particular one. For example, recognition system 20 may perform a Viterbi search or monitor the volume or gain level of the input sample.

Although the scope of the present invention is not limited in this respect, the process of identifying speech and determining whether the input is speech or noise may be determined sequentially or in parallel. For example, the input sample may be captured and a transformation may be used transform the input sample data into 13 mel cepstrum. Then the up-to-date HMM models may be used to perform a Viterbi search and to determine which state and to which gaussian the current input sample best matches. If current frame is recognized as noise, then the average of the single gaussian of the noise state may be updated using the equation:

new average=0.9*old average+0.1*frame cepstrum,

although the scope of the present invention is not limited in this respect.

If it is determined that the input sample comprises noise, then recognition system 20 may use the noise sample to modify the estimation of the noise average and modify the HMM model for the noise real-time, step 320. Upon initialization, recognition system 20 may be using naïve noise models. However, this embodiment of the present invention allows the model to be improved or modified real-time as recognition system 20 is receiving noise samples as input. In this particular embodiment only the noise that occurs prior to the speech sample is used to modify the speech models. However, in alternative embodiments the noise models may also be modified using the nose data associated with noise detected in the middle of a speech sample or following a speech sample.

If recognition system 20 determined that a frame of the input sample is speech or data, then the speech models may be modified using, at least in part, the data and models associated with the noise models, step 330. Again, the initial speech models may be naïve models that are modified and improved over time as more noise and/or speech samples are processed by recognition system 20.

Although the scope of the present invention is not limited in this respect, if current frame is recognized as speech, the current gain mismatch between the cepstrum of frame and the average of winning gaussian may be calculated. The current mismatch may be the difference between the first component of the frame cepstrum vector and the first component of the winning gaussian average vector. The new overall gain mismatch may then be modified such as by using the equation:

New overall gain mismatch=0.8*old overall gain mismatch+0.2*current gain mismatch,

although the scope of the present invention is not limited in this respect.

The naïve speech models may be adapted based on overall gain mismatch and on the current estimate of the noise average to obtain up-to-date speech models. For example, although the scope of the present invention is not limited in this respect, the following mathematical operations may be perform to perform the adaptation:

1. Add the gain mismatch to the first component of the average vector

2. Apply inverse Fourier transform. The resulting vector is referred to as a speech filter bank vector.

3. Apply inverse Fourier transform to the average of the noise model. The resulting vector referred to as a noise filter bank vector.

4. Add the exponent of each element of the speech filter bank vector to the exponent of the corresponding noise filter bank element, and take the logarithm of the sum. This may be referred to as a speech+noise filter bank vector.

5. Apply Fourier transform on the speech+noise filter bank vector to obtain the average of the Gaussian of the adapted model.

It should be understood that the scope of the present invention is not limited to this particular sequence of operations as other operations and combinations therefore may be alternatively used.

Once the speech model(s) have been adapted or modified to compensate for the presence of noise or other undesired sounds, recognition system 20 may then adjust the speech volume level and then use the speech models to perform statistical analysis to identify the sound. For example, although the scope of the present invention is not limited in this respect, recognition system 20 may perform a Viterbi search or Viterbi algorithm to identify the speech, step 340.

After the speech sample has been processed, the recognition system 20 may then turn to the next frame and repeat this process. After recognition system has found a match using the speech models it may store the results in memory (e.g. memory 30 or 50) or may provide the result to processor 40 (see FIG. 1) so that the command or data may be processed.

In this particular embodiment, although the scope of the present invention is not limited in this respect, it should be noted that the input sample (including both the noise and speech samples) was not stored in memory. This is due, at least in part, because recognition system 20 was able to use the noise in the input sample that is prior to the speech to adjust the speech models to compensate for the presence of noise and use those models to recognize the speech with one pass of the input sample. In other words, this particular embodiment has reduced the need to store an input signal in memory because the input signal may be processed on a single or initial pass of the input sample. Thus, both adaptation of the models and use of the models may be performed on the same pass. It should be understood, however, that the scope of the present invention is not limited to embodiments that do not store any or all of an input sample in memory, as this may be desirable for other reasons.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
modifying a speech model using a noise model, wherein the noise model is determined only from noise prior a speech sample.

2. The method of claim 1, further comprising using the speech model to recognize the speech sample.

3. The method of claim 1, wherein modifying the speech model includes modifying a Hidden Markov model.

4. The method of claim 1, wherein modifying the speech model using a noise model includes using a noise model determined from an input sample comprising both the noise and the speech sample.

5. The method of claim 1, further comprising recognizing the speech sample using the speech model.

6. The method of claim 5, wherein recognizing the speech model includes recognizing the speech sample using a Viterbi algorithm.

7. The method of claim 5, wherein recognizing the speech model includes recognizing the speech sample without storing the speech sample in memory.

8. The method of clam 7, wherein recognizing the speech model includes recognizing the speech sample without storing the noise model in memory.

9. A method comprising:
adapting a speech model during an initial pass of an input sample through a voice recognizer.

10. The method of claim 9, wherein adapting the speech model includes adapting a noise model from noise in the input sample, the noise being prior to a speech sample in the input sample.

11. The method of claim 10, wherein adapting the speech model includes adapting the noise model only from noise in the input sample that is prior to the speech sample in the input sample.

12. The method of claim 10, further comprising recognizing content of a speech sample after generating the noise model.

13. The method of claim 9, wherein adapting the speech model includes adapting a Hidden Markov model.

14. The method of claim 9, wherein the speech model is adapted prior to completion of the initial pass of the input sample.

14. A method of processing an input sample including a noise sample followed by a data sample, the method comprising:
altering a noise model with the noise sample; and
altering a speech model with the noise model.

15. The method of claim 14, wherein altering the noise model and altering the speech model occurs during an initial pass of the input sample through a voice recognizer.

16. The method of claim 1 4, wherein altering the noise model includes modifying the noise model with noise that occurs only prior to the data sample.

17. The method of claim 1 4, wherein altering the noise model includes identifying the noise sample in the input sample.

18. The method of claim 17, wherein altering the noise model includes modifying the noise model using only the noise sample.

19. An apparatus comprising:
a speech recognizer adapted to modify a speech model and recognize speech during a single pass of an input sample.

20. The apparatus of claim 19, further comprising a hidden Markov model.

21. The apparatus of claim 19, wherein the speech recognizer is further adapted to modify a noise model during the single pass of the input signal.

21. The apparatus of claim 21, wherein the speech recognizer is further adapted to modify the speech model using the noise model.

22. An apparatus comprising:
a speech model to recognize speech during a single pass of an input sample; and
a static dynamic random access memory.

23. The apparatus of claim 22, wherein the speech model comprises a Hidden Markov model.

24. The apparatus of claim 22, further comprising a noise model, wherein the noise model is modified during the single pass of the input signal.

25. An article comprising: a storage medium having stored thereon instructions, that, when executed by a computing platform, results in:
adapting a speech model during an initial pass of an input sample through a voice recognizer.

26. The article of claim 25, wherein the instructions, when executed, further result in adapting a noise model from noise in the input sample, the noise being prior to a speech sample in the input sample.

27. The article of claim 26, wherein the instructions, when executed, further result in adapting the noise model only from noise in the input sample that is prior to the speech sample in the input sample.

28. The article of claim 25, wherein the instructions, when executed, further result in recognizing content of a speech sample after generating the noise model.

29. The article of claim 25, wherein the instructions, when executed, further result in adapting a Hidden Markov model.

30. The article of claim 25, wherein the instructions, when executed, further result in adapting the speech model prior to completion of the initial pass of the input sample.
